(19) United States
(12) Patent Application Publication
(10) Pub. No.: US 2021/0039027 A1
(43) Pub. Date: Feb. 11, 2021

(54) VENTILATION DEVICE FOR FILTERING AIR AND FOR SEPARATING WATER AEROSOLS OUT OF THE AIR

(71) Applicant: Filtration Group GmbH, Oehringen (DE)

(72) Inventors: Steffen Gorzawski, Bad Rappenau (DE); Wolfgang Kugel, Wolpertshausen (DE); Andreas Szontkowski, Obersulm (DE); Fritz Roediger, Untereisesheim (DE)

(21) Appl. No.: 17/041,441

(22) PCT Filed: Jan. 23, 2019
(86) PCT No.: PCT/EP2019/051657

§ 371 Date: Sep. 25, 2020

(30) Foreign Application Priority Data
Mar. 27, 2018 (DE) 10 2018 204 632.8

(51) Int. Cl. B01D 46/00; B01D 46/44; F04D 29/70

(52) U.S. Cl. CPC B01D 46/0005; B01D 46/0031; B01D 46/002; B01D 46/444; B01D 2267/60; F04D 29/701; B01D 2271/02; B01D 2265/028; B01D 2267/30; B01D 46/446

(57) ABSTRACT

A ventilation device for filtering air and for separating water aerosols from air may include at least one filter element, at least one housing, at least one fan, and at least one flow adapter. The filter element may be secured in the housing such that air is flowable through the housing from an inlet opening of the housing to an outlet opening of the housing in a flow direction. The fan may be secured on the outlet opening downstream of the housing in the flow direction. The flow adapter may be secured on the inlet opening upstream of the housing in the flow direction. A coupling frame may be secured in an airtight manner between the housing and the flow adapter transversely to the flow direction. The filter element may have a circumferential sealing edge that seals the housing around the inlet opening to the coupling frame.

### CROSS-REFERENCE TO RELATED APPLICATIONS

This application claims priority to International Patent Application No. PCT/EP2019/051657, filed on Jan. 23, 2019, and German Patent Application No. DE 10 2018 204 632.8, filed on Mar. 27, 2018, the contents of both of which are hereby incorporated by reference in their entirety.

### TECHNICAL FIELD

The invention relates to a ventilation device for filtering air and for separating water aerosols out of the air.

### BACKGROUND

Ventilation devices for filtering air and for separating water aerosols out of the air are already known from the prior art and are used, for example, in wind power plants. Depending on the location of the wind power plant, the air drawn in from the outside has to be purified and dewatered to protect electronic or electrical components within the wind power plant. For this purpose, fans draw air into the wind power plant through filter elements, in which the drawn-in air is purified and dewatered. However, the air, which has not been purified and dewatered yet, must not escape from the ventilation device through the filter element prior to the purification and dewatering. For this purpose, the ventilation system is sealed to the outside by means of at least one seal, which has to be replaced or exchanged, respectively, routinely in a time-consuming manner and by expending force.

### SUMMARY

It is thus the object of the invention to specify an improved or at least alternative embodiment for a ventilation device of the generic type, in the case of which the described disadvantages are eliminated.

This object is solved according to the invention by means of the subject matter of independent claim(s). Advantageous embodiments are subject matter of the dependent claim(s).

The present invention is based on the genal idea of carrying out a first sealing or a re-sealing in a ventilation system for filtering air and for separating water aerosols out of the air when inserting or when exchanging the respective filter element. The generic ventilation device thereby has at least one filter element, at least one housing, at least one fan, and at least one flow adapter. The at least one filter element in the at least one housing is secured such that air can flow through it from an inlet opening to an outlet opening of the respective housing in a flow direction. In the flow direction, the at least one fan is thereby secured to the outlet opening downstream from the respective housing, and, in the flow direction, the at least one flow adapter is secured to the inlet opening upstream of the at least one housing. A coupling frame is further secured in an airtight manner between the at least one housing and the at least one flow adapter transversely to the flow direction. According to the invention, the at least one filter element has a circumferential sealing edge, wherein the sealing edge rests against a sealing surface, which borders the inlet opening, of the at least one housing on one side, and rests against the coupling frame on the other side, and seals the at least one housing around the inlet opening to the coupling frame transversely to the flow direction. The sealing edge seals a pressure chamber of the ventilation device and is arranged at the filter element, so that, when inserting or when exchanging the at least one filter element in the ventilation device, the sealing edge can also be inserted or exchanged. The sealing of the pressure chamber of the ventilation device can in particular be carried out without tools through the sealing edge, and the expenditure of time and force can thus be reduced in response to the first sealing and in response to the re-sealing of the ventilation device.

The sealing surface can thereby be formed by means of a housing frame, which borders the inlet opening and which forms an inlet step, which protrudes radially inwardly, in the respective housing. In this way, the air flow can be guided to the filter element in the respective housing without losses. It can advantageously be provided that an elastic seal is secured to a side surface of the sealing frame facing the housing and/or the coupling frame. The elastic seal can thereby be secured to the side surfaces of the sealing edge by means of a substance-to-substance bond, for example adhered, or in a non-positive manner, for example engaged with a profile groove.

The at least one flow adapter, the at least one housing comprising the at least one filter element, and the at least one fan are connected one after the other in the flow direction in the ventilation device, so that the air can flow through the at least one flow adapter to the inlet opening of the at least one housing, and further through the at least one filter element. The air can thereby be drawn in from the outside by means of the fan and can be guided further into the housing comprising the filter element by means of the at least one flow adapter. The housing can advantageously be made of a plastic, for example rotationally molded. The flow adapter can advantageously be flow-optimized and the geometry of the flow adapter can be adapted to the respective application. The filter element advantageously has a clean and a raw side and is molded of a filter material. The filter material can thereby be hydrophobic, for example, and can separate the water, which is present in the drawn-in air, in a filtering zone. The water separated in the filter element can then settle into a drainage zone of the filter element on the raw side of the filter element under the influence of the force of gravity. The drainage zone adjoins the filtering zone of the filter element and is advantageously arranged transversely to the flow direction in an offset manner below the filtering zone of the filter element. The filtering zone of the filter element thereby corresponds to a filtering region, and the drainage zone corresponds to a drip-off region of the housing. The filtering region and the drip-off region of the housing thereby connect to one another.

It is provided in the case of an advantageous further development of the ventilation device according to the invention that the at least one flow adapter is integral and is preferably made of plastic. The flow adapter is thus molded to be robust, so that the air drawn in from the outside by means of the at least one fan can already be distributed in the flow adapter and can flow evenly over the filter element. The respective filter element can thus in particular be protected and can be used longer. The flow adapter made of plastic advantageously further increases the dead weight of the ventilation system only slightly. The at least one flow adapter can thereby have a collecting region and a flow region, which connect to one another. The flow region of the flow adapter thereby corresponds in an air-conducting manner to the inlet opening of the housing, and the collecting region is arranged transversely to the flow direction in an offset manner below the flow region. The collecting region further lies outside of a main air flow of the flow adapter. In the ventilation device, the flow region of the at least one flow adapter corresponds to the filtering region of the respective housing and to the filtering zone of the respective filter element in the housing. The collecting region, in contrast, is located transversely to the flow direction in an offset manner below the flow region of the flow adapter, and no or an only negligibly small air flow is present in the collecting region.

It can advantageously be provided that a discharge duct assembly fluidically connects the collection region of the at least one flow adapter and a drip-off region of the at least one housing to one another. The water separated in the filter element can be guided through the discharge duct assembly from the respective housing into the collecting region of the at least one flow adapter opposite to the flow direction. The collecting region of the flow adapter is thereby located outside of the air flow, so that a flow resistance does not counteract the water separated in the filter element when flowing into the collecting region of the flow adapter. To drain the water separated in the filter element from the collecting region, the at least one flow adapter can have an adapter outlet opening, which leads to the outside from the collecting region and which is connected in a fluid-conducting manner to the discharge duct assembly. The water separated in the filter element can thus be guided from the respective housing into the collecting region of the flow adapter opposite to the flow direction without or with a small flow resistance. Within the flow adapter, the water separated in the filter element can then be guided to the adapter outlet opening and further to the outside without or with a small flow resistance under the influence of the force of gravity. A removal of the water separated in the filter element can be ensured in this way in each operating point of the ventilation device without additional application of force. Additional lines and pumps for removing the water separated in the filter element can thus in particular be dispensed with.

In the case of a further development of the ventilation device according to the invention, it is advantageously provided that the discharge duct assembly is formed in a coupling frame, which is secured in an air-tight manner between the at least one housing and the at least one flow adapter transversely to the flow direction. The coupling frame thus connects the respective housings in an air-conducting manner to the at least one flow adapter in the flow direction and transversely to the flow direction in that the coupling frame rests against the sealing edge of the at least one filter element in an air-tight manner. In particular the pressure chamber of the ventilation device can thus be sealed and can be maintained. The coupling frame can further take over a supporting function and can stabilize the ventilation device against a deformation. The discharge duct assembly is formed in the coupling frame, so that the water separated in the filter element can be guided from the drip-off region of the respective housing via the coupling frame into the collecting region of the at least one flow adapter. The water separated in the filter element can subsequently be guided to the outside from the collecting region of the at least one flow adapter through the adapter outlet opening. The discharge duct assembly can thereby fluidically connect the drip-off regions of the several housings to the collecting region of the at least one flow adapter, or the drip-off regions of the several housings to the collecting region of the several flow adapters.

The discharge duct assembly can advantageously have at least one horizontal gutter duct, which is fluidically connected to a drip-off region of at least one of the housings. In the operating state, the gutter duct is oriented horizontally with a deviation of up to 10° to the bottom, in order to be able to horizontally guide the water separated in the filter element in the ventilation device under the influence of the force of gravity. The individual gutter duct can thereby fluidically connect the drip-off regions of the several housings, which are arranged next to one another, to the corresponding filter elements. The discharge duct assembly can advantageously have at least two gutter ducts, which are arranged on top of one another and which are fluidically connected to one another by means of at least one vertical discharge duct. The gutter ducts arranged on top of one another thereby in each case connect the drip-off regions of the housings in a horizontal row, and the at least one vertical discharge duct fluidically connects the gutter ducts vertically to one another. In the operating state, the vertical discharge duct is oriented vertically with a deviation of up to 10° to the bottom, so that the water separated in the filter element can be guided from an upper gutter duct with respect to the bottom into the lower gutter duct with respect to the bottom under the influence of the force of gravity. In this way, a removal of the water separated in the filter element can advantageously be ensured in the discharge duct assembly in each operating point of the ventilation device, without additional influence of force only under the influence of the force of gravity. The water separated in the filter elements can subsequently be guided from the discharge duct assembly into the collecting region of the flow adapter, and further to the outside. For this purpose, the lowermost gutter duct with respect to the bottom can be fluidically connected as intended at its lowest point through a discharge opening to the collecting region of the at least one flow adapter, for example via a discharge line. The several housings and the several filter elements are fluidically connected to one another in this way via the discharge duct assembly in the coupling frame, and the water separated in the several filter elements can be drained from the ventilation device in a simplified manner. The at least one gutter duct is preferably formed of a u-shaped metallic profile and the at least one discharge duct is formed of a u-shaped or l-shaped metallic profile.

It is advantageously provided in the case of a further development of the ventilation device that the filter element, the housing, and the fan, each form a ventilation module comprising a flow surface. Several identical ventilation modules of the ventilation device are thereby detachably stacked against one another in such a way that a total flow surface of the ventilation device corresponds to a multiple of the flow surface of the individual ventilation module. The ventilation device can thus advantageously be constructed in a modular manner, and can be expanded with further ventilation modules, depending on the requirements. The individual ventilation modules, which are designed identically, can further be exchanged with one another in a simplified manner, so that the assembly and the maintenance of the ventilation device are simplified.

It can advantageously be provided that at least two of the ventilation modules, which are adjacent in the ventilation device, in each case have at its housings a cable part depression, which extends in the flow direction. The respective cable part depressions at the housings of the adjacent ventilation modules thereby rest against one another in the flow direction and form a cable opening. The cable part depressions can be designed identically, so that a cross-sectional surface of the cable opening corresponds to a double cross-sectional surface of the individual cable part depression. The cable lines can be guided in the flow direction through the cable opening between the respective ventilation modules, so that electrical component parts of the ventilation device can be connected to one another in the flow direction upstream of or downstream from the respective ventilation module without additional space requirement.

To be able to detachably stack the individual ventilation modules against one another, one of the ventilation modules, which is adjacent in the ventilation device, can advantageously have at its housing at least one recess extending in the flow direction, and another one of the ventilation modules, which is adjacent in the ventilation device, can have at its housing at least one molding extending in the flow direction. The at least one recess and the at least one molding thereby engage with one another transversely to the flow direction, and form a so-called groove-spring connection. The at least one recess and the at least one molding detachably secure the adjacent ventilation modules to one another in this way. To form the respective ventilation modules identically, the at least one recess and the at least one molding can in each case be formed at the respective housing. Advantageously, they are formed on opposite housing sides, so that the ventilation modules, which are stacked on top of one another or next to one another, can be detachably secured to one another.

It is provided in the case of a preferred design of the ventilation device that the ventilation device has four ventilation modules and a single flow adapter. The ventilation modules are thereby detachably secured to one another to form a 2×2 stacking block, and are secured in an air-conducting manner to the flow adapter by means of a coupling frame. The respective ventilation modules are designed identically and each have a cuboid housing comprising a cuboid filter element and a fan. The flow adapter is secured to the respective ventilation module by means of the coupling frame.

The coupling frame can advantageously have a module support frame, which borders the respective ventilation modules transversely to the flow direction, and an adapter support frame, which supports the at least one flow adapter. The module support frame and the adapter support frame can be supported on one another in a hinged or shiftable manner by means of a hinge device, and can be capable of being secured to one another by means of a closure unit. In the case of this advantageous design of the ventilation device, the coupling frame can be opened, and the filter element can be exchanged for example in a simplified manner in the respective ventilation module. The discharge duct assembly can then be formed, for example, in the adapter support frame. An aperture assembly for the inlet opening of the respective housing can advantageously be secured to the coupling frame transversely to the flow direction. The aperture assembly, preferably a shutter assembly, is thereby provided for controlling the air volume flow through the respective ventilation module.

It is provided in the case of an advantageous further development of the ventilation device according to the invention that the respective fan is controlled by means of a control device. The control device has at least one measuring assembly for detecting the air volume flow through the respective filter element. The at least one measuring assembly thereby has a pressure measuring unit for detecting a static pressure, which is arranged within the ventilation device. The static pressure in the respective filter element can be detected by means of the pressure measuring unit, and the air volume flow through the respective filter element can be determined therefrom. In particular, a direct and inaccurate measurement of the air volume flow can be dispensed with in the respective filter housing, and the ventilation device can be controlled more accurately.

The respective pressure measuring unit can advantageously be fluidically connected to a pressure measuring point or can have such a pressure measuring point. The pressure measuring point is thereby arranged within the housing in the region of the inlet opening and has a measuring opening there. The measuring opening can thereby pass through the respective housing, so that the pressure measuring unit arranged outside of the housing can detect the static pressure within the housing and the filter element. The respective pressure measuring point or the measuring opening thereof can advantageously be arranged in a drip-off region of the housing. The drip-off region of the housing thereby corresponds to a drainage zone of the filter element, which is provided for removing the water separated in the filter element. The drainage zone of the filter element is thereby connected to a filtration zone of the filter element, and is arranged transversely to the flow direction below the filtration zone of the filter element. To protect the pressure measuring unit or the pressure measuring point thereof against water and dirt, the pressure measuring point can be arranged on a clean side of the filter element in the respective housing. In a flow-restricted zone of the drip-off region of the housing, the respective pressure measuring point or the measuring opening thereof can advantageously be integrated into said housing or can be secured in said housing, respectively. The flow-restricted zone of the drip-off region of the housing can thereby correspond to a flow-restricted zone of the drainage zone of the filter element. In this context, “flow-restricted” means that the air flow, which is present at the pressure measuring point or the measuring opening thereof, is negligibly small for a measurement of the static pressure or causes a measuring error of below 5% in the measurement of the static pressure, respectively.

The housing can advantageously have a housing frame bordering the inlet opening comprising an inlet step protruding radially inwardly. To increase the measurement accuracy when detecting the static pressure in the respective housing, which is flown through, the pressure measuring point can be arranged at the inlet step. The measuring opening can thereby be open in the flow direction and can be oriented essentially parallel to the flow direction, in this context with a deviation of up to 30°. The measuring opening is advantageously arranged in the respective housing in such a way that no or only negligibly small air flow is present at the pressure measuring point or at the measuring opening, respectively. The measured static pressure can thus in particular be detected independently of the dynamic pressure, which prevails in the respective housing.

In summary, a first sealing or a re-sealing can take place with a reduced expenditure of time and force in the ventilation according to the invention.

In summary, the ventilation device according to the invention can be constructed in a modular manner, and the ventilation modules, which are designed identically, can be interchanged in a simple way. Advantageous further designs of the ventilation device further make it possible to drain the water separated in the respective filter element from the ventilation device in a simplified manner; to simplify a sealing of the ventilation device; to more accurately control the ventilation device, and to better distribute the air flow in the respective filter element.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a view of a ventilation device according to the invention;

FIG. 2 shows a view of the ventilation device shown in FIG. 1 from the front;

FIG. 3 shows a view of the ventilation device shown in FIG. 1 from the rear;

FIG. 4 shows a side view of the ventilation device shown in FIG. 1;

FIG. 5 shows a view of the ventilation device shown in FIG. 1 from the top;

FIG. 6 shows a sectional view of the ventilation device shown in FIG. 1;

FIG. 7 shows a side view of a ventilation mode of the ventilation device shown in FIG. 1;

FIG. 8 shows a view of the ventilation mode of the ventilation device shown in FIG. 1 from the top;

FIG. 9 shows a sectional view of the ventilation mode of the ventilation device shown in FIG. 1;

FIG. 10 shows a view of a flow adapter of the ventilation device shown in FIG. 1;

FIG. 11 shows a partial sectional view of the flow adapter of the ventilation device shown in FIG. 1;

FIG. 12 shows a view of the flow adapter of the ventilation device shown in FIG. 1 from the rear;

FIG. 13 shows a view of the flow adapter of the ventilation device shown in FIG. 1 from the top;

FIG. 14 shows a sectional view of the ventilation device shown in FIG. 1;

FIG. 15 shows a further sectional view of the ventilation device shown in FIG. 1.

### DETAILED DESCRIPTION

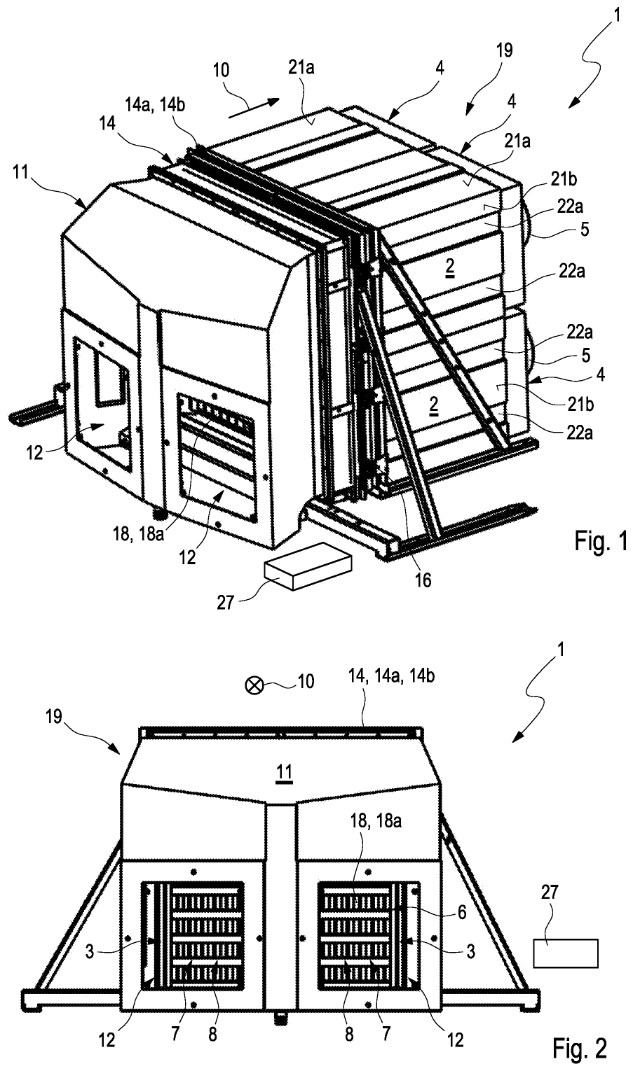

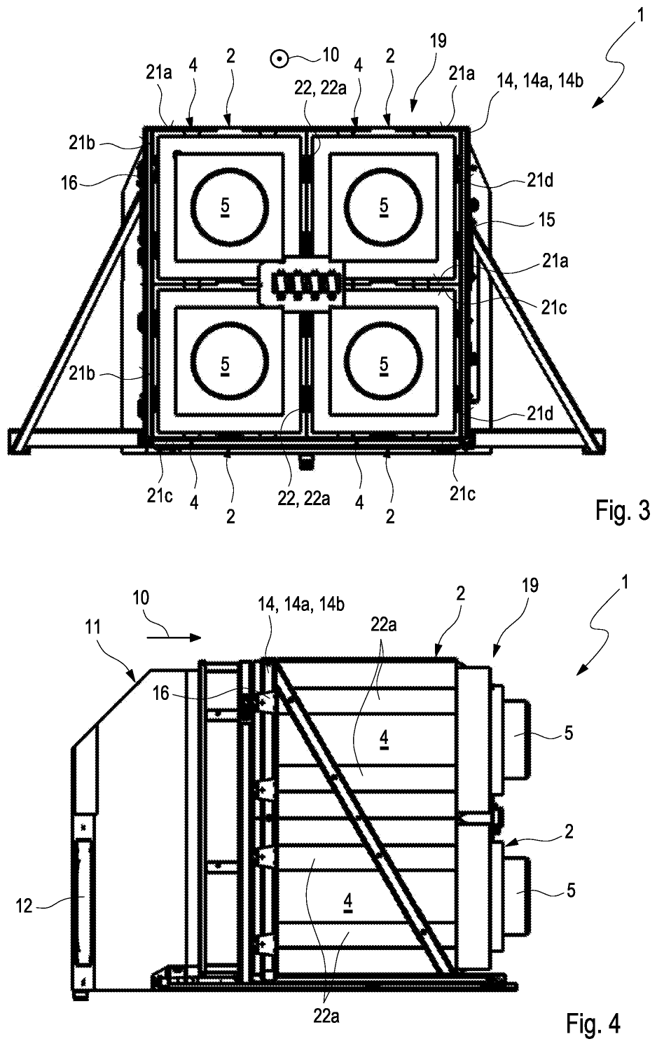

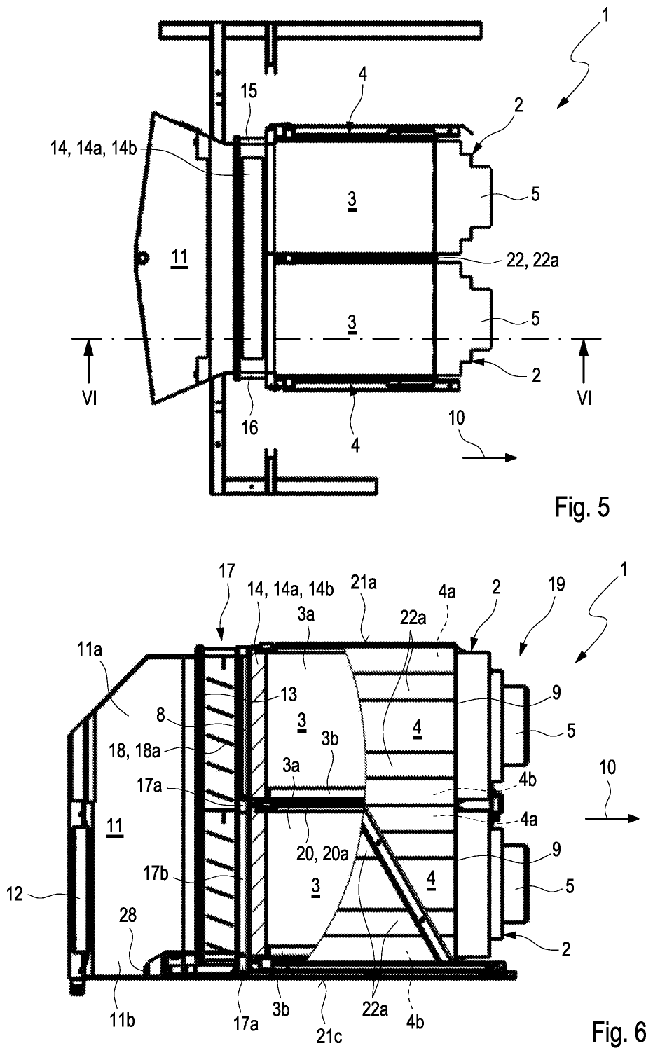

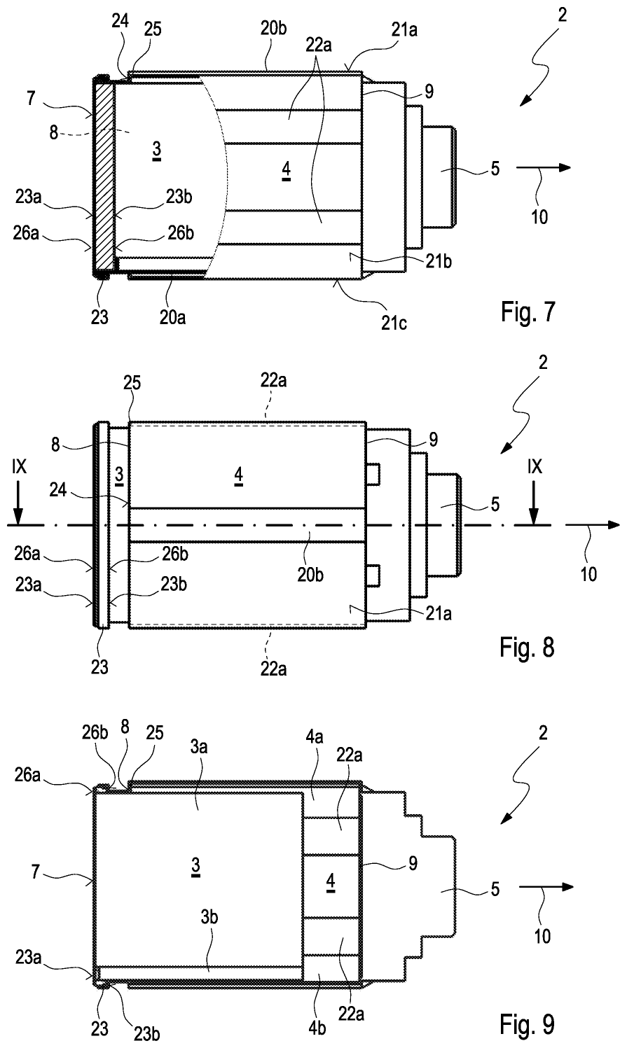

FIG. 1 shows a view of a ventilation device 1 according to the invention for filtering air and for separating water aerosols out of the air. The ventilation device 1 is shown from the front in FIG. 2; from the rear in FIG. 3; from the side in FIG. 4; from the top in FIG. 5, and in section in FIG. 6. Here and below, the terms “front” and “rear” refer to the air, which flows through the ventilation device 1 and which, in the operating state, flows through the installed ventilation device 1 from the “front” to the “rear” in parallel or virtually parallel to the bottom. The terms “top” and “bottom” accordingly refer to the orientation of the installed ventilation device 1 to the bottom. The ventilation device 1 has a total of four ventilation modules 2, wherein the respective ventilation module 2 has a filter element 3, a housing 4, and a fan 5. The ventilation modules 2 are identical and are detachably stacked against one another to form a stacking block 19, so that a total flow surface 6 of the ventilation deice 1 corresponds to a multiple of the flow surface 7 of the individual ventilation module 2. In the respective ventilation module 2, the filter element 3 is arranged in the respective housing 4 and such that air can flow through from an inlet opening 8 to an outlet opening 9 of the housing 4 in a flow direction 10. In the flow direction 10, the respective fan 5 is secured to the outlet opening 9 downstream from the respective housing 4. The respective fan 5 is controlled by a control device 27, which has a measuring assembly for detecting the air volume flow through the respective filter element 3. The setup of the ventilation module 2 is shown in detail in FIG. 7 to FIG. 9.

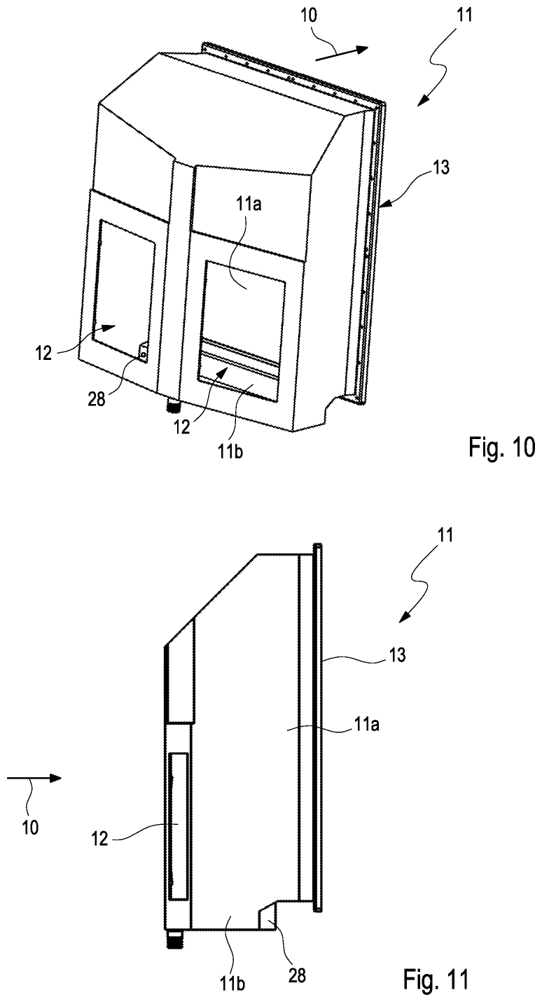

The ventilation device 1 further has a flow adapter 11, which, in the flow direction 10, is secured to the respective inlet opening 8 upstream of the respective housing 4. The flow adapter 11 thereby has two air inlets 12 and an air outlet 13, which fluidically corresponds to the respective inlet opening 8 of the respective housing 4. The flow adapter 11 is thereby integral, for example of plastic, and robust, so that the air drawn in from the outside by means of the respective fan 5 is already distributed in the flow adapter 11. The air drawn in from the outside then flows evenly over the respective filter elements 3, and the latter are protected. The setup of the flow adapter 11 is shown in detail in FIG. 10 to FIG. 13.

The flow adapter 11, the respective housing 4 comprising the respective filter element 3, and the respective fan 5 are thus connected one after the other in the flow direction 10 in the ventilation device 1, so that the air can flow through the air inlets 12 of the flow adapter 11 via the air outlet 13 to the inlet opening 8 of the respective housing 4, and further through the respective filter element 3. As shown in FIG. 6, the respective filter element 3 thereby has a clean and a raw side and is molded of a filter material. The filter material is hydrophobic, and the water, which is present in the drawn-in air, is separated in a filtering zone 3a on the raw side. The water separated in the filter element 3 then settles into a drainage zone 3b of the filter element 3 under the influence of the force of gravity. The drainage zone 3b adjoins the filtering zone 3a of the filter element 3 and is arranged transversely to the flow direction 10 in an offset manner below the filtering zone 3a of the filter element 3.

The filtering zone 3a of the filter element 3 corresponds to a filtering region 4a, and the drainage zone 3b corresponds to a drip-off region 4b of the housing 4. The filtering region 4a and the drip-off region 4b of the housing 4 thereby connect to one another. The flow adapter 11 further has a flow region 11a and a collecting region 11b, which connect to one another. The flow region 11a of the flow adapter 11 thereby fluidically corresponds to the inlet openings 8 of the respective housings 4, and the collecting region 11b is arranged transversely to the flow direction 10 in an offset manner below the flow region 11a. The collecting region 11b further lies outside of a main air flow of the flow adapter 11.

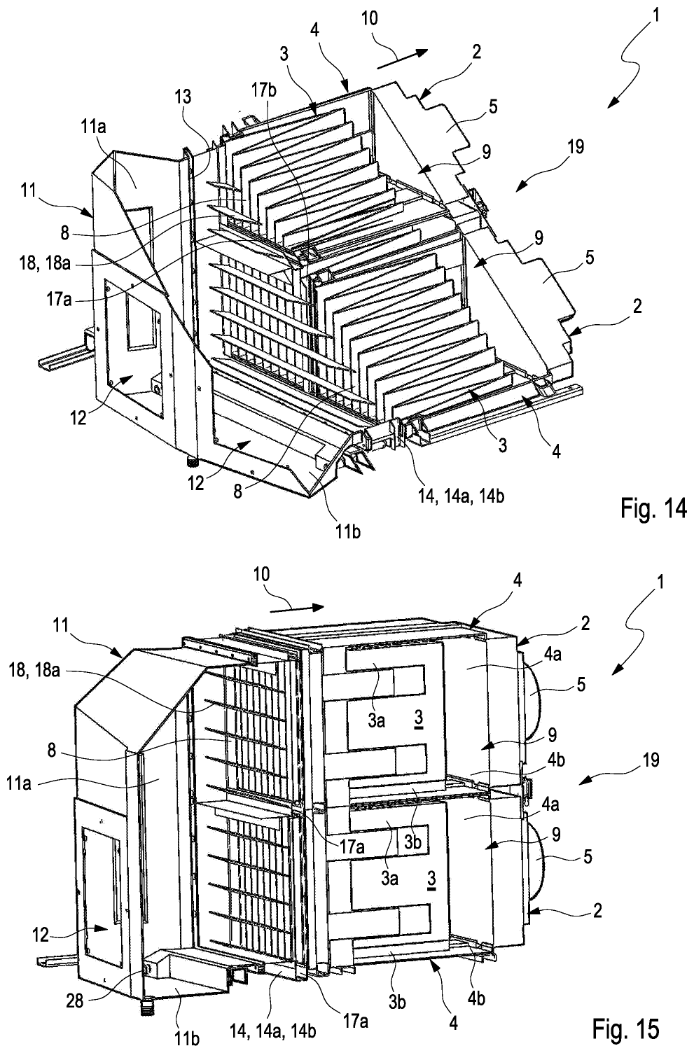

The ventilation modules 2 are detachably secured to the flow adapter 11 by means of a coupling frame 14. For this purpose, the coupling frame 14 has a module support frame 14a, which borders the respective ventilation modules 2 transversely to the flow direction 10, and an adapter support frame 14b, which supports the flow adapter 11. The module support frame 14a and the adapter support frame 14b are supported on one another in a hinged manner by means of a hinge device 15 and can be secured to one another by means of a closure unit 16. The coupling frame 14 can thus be opened, and for example the filter element 3 can be exchanged in a simplified manner in the respective ventilation module 2. A discharge duct assembly 17 for discharging the water separated in the respective filter element 3 is further formed in the coupling frame 14. As shown in FIG. 6, the discharge duct assembly 17 thereby has two horizontal gutter ducts 17a arranged on top of one another, and a vertical discharge duct 17b. The respective gutter duct 17a thereby in each case connects the drip-off regions 4b of the housings 4 of the ventilation modules 2, which are adjacent in series, to the discharge duct assembly 17, and the discharge duct 17b fluidically connects the two gutter ducts 17a to one another. Under the influence of the force of gravity the water separated in the respective filter element 3 can be guided to the outside through the discharge duct assembly 17. The setup of the discharge duct assembly 17 is shown in detail in FIG. 14 and FIG. 15. An aperture assembly 18, here a shutter assembly 18a, for the inlet opening 8 of the respective housing 4 is further secured to the coupling frame 14 transversely to the flow direction 10. The aperture assembly 18 is provided to control the air volume flow through the respective ventilation module 2.

FIG. 7 shows a side view of an individual ventilation module 2 in the ventilation device 1. The ventilation module 2 is further shown from the top in FIG. 8 and in section in FIG. 9. To detachably stack the individual ventilation modules 2 against one another to form the stacking block 19, the respective ventilation module 2 has, in the ventilation device 1 at its housing 4, a recess 20a, which extends in the flow direction 10, and a molding 20b, which extends in the flow direction 10. The recess 20a and the molding 20b of the adjacent ventilation modules 2 thereby engage transversely to the flow direction 10 and form a so-called groove-spring connection. The recess 20a and the molding 20b detachably secure the adjacent ventilation modules 2 against one another to form the stacking block 19 in this way. The recess 20a and the molding 20b are formed at the respective housing 4 on opposite housing sides 21a and 21c, as is also shown in FIG. 1 to FIG. 6, and in FIG. 14 to FIG. 15.

The respective ventilation module 2 further in each case has, at its housing 4 on the opposite housing sides 21b and 21d, two cable part depressions 22a, which extend in the flow direction 10. In the stacking block 19, the respective cable part depressions 22a rest against the housings 4 of the adjacent ventilation modules 2 in the flow direction 10 and form a cable opening 22. The cable part depressions 22a are designed identically, so that a cross-sectional surface of the cable opening 22 corresponds to a double cross-sectional surface of the individual cable part depression 22a. The cable lines can be guided in the flow direction 10 through the cable opening 22 between the respective ventilation modules 2, so that electrical component parts of the ventilation device 1 can be connected to one another in the flow direction 10 upstream of or downstream from the respective ventilation module 2 without additional space requirement. The cable openings 22 from the cable part depressions 22a, which rest against one another, are also shown in FIG. 1 to FIG. 6, and FIG. 14 to FIG. 15.

To secure the filter element 3 in an air-tight manner transversely to the flow direction 10 in the housing 4, the filter element 3 has a circumferential sealing edge 23 in the respective ventilation module 2. The sealing edge 23 thereby rests against a sealing surface 24, which borders the inlet opening 8, of the housing 4 on one side, and rests against the coupling frame 14 on the other side. The sealing edge 23 is formed at the filter element 3, so that the sealing edge 23 is also inserted or exchanged when inserting or when exchanging the respective filter element 3 in the ventilation device 1. The sealing surface 24 is thereby formed by means of a housing frame 25, which frames the inlet opening 8. For sealing purposes, an elastic seal 26a and 26b is in each case secured, for example adhered, to side surfaces 23a and 23b of the sealing edge 23 facing the housing 4 and the coupling frame 14.

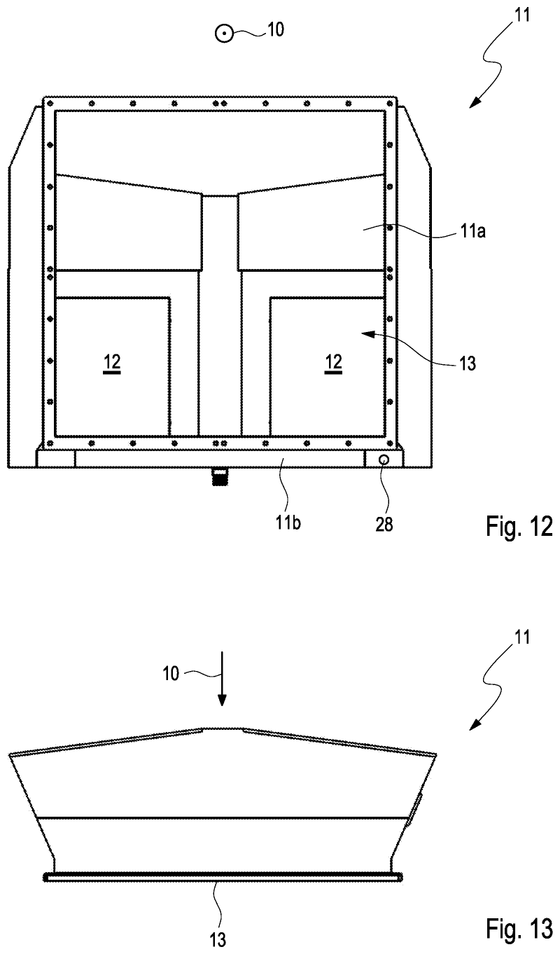

FIG. 10 shows a view of the flow adapter 11. The flow adapter 11 is further shown partially in section in FIG. 11; from the rear in FIG. 12, and from the top in FIG. 13. The flow adapter 11 has the air inlets 12 and the air outlet 13, which fluidically corresponds to the respective inlet opening 8 of the respective housing 4. The flow adapter 11 is integral and is preferably made of plastic. The flow adapter 11 is thus molded to be robust, and the air drawn in from the outside by means of the respective fan 5 is already distributed evenly in the flow adapter 11 and flows evenly over the respective filter elements 3. The flow adapter 11 thereby has the flow region 11a and the collecting region 11b, which connect to one another. The flow region 11a of the flow adapter 11 thereby fluidically corresponds to the inlet openings 8 of the respective housings 4, and the collecting region 11b is arranged transversely to the flow direction 10 in an offset manner below the flow region 11a. The collecting region 11b further lies outside of a main air flow of the flow adapter 11.

As already described in FIG. 1 to FIG. 6, the discharge duct assembly 17 is formed in the coupling frame 14. It fluidically connects the collecting region 11b of the flow adapter 11 and the drip-off regions 4b of the respective housing 4. The water separated in the filter element 3 can be guided from the respective housing 4 into the collecting region 17 of the flow adapter 11 opposite to the flow direction 10 through the discharge duct assembly 17. For this purpose, the collecting region 11b of the flow adapter 11 is fluidically connected to the discharge duct assembly 17 via a discharge opening 28, wherein the discharge duct assembly 17 is connected at its lowest point in the lower gutter duct 17a to the discharge opening 28 via a discharge line, which is not shown here. The water separated in the filter elements 3 is guided through the discharge opening 28 into the flow adapter 11, and is guided to the outside in the collecting region 11b of the flow adapter 11 opposite to the flow direction 10. The setup of the discharge duct assembly 17 is shown in detail in FIG. 6, FIG. 14, and FIG. 15.

FIG. 14 and FIG. 15 show sectional views of the ventilation device 1. In the ventilation device 1, the individual ventilation modules 2 are secured to the coupling frame 14 on one side to form the stacking block 19, and the flow adapter 11 on the other side. The discharge duct assembly 17, which has two horizontal gutter ducts 17a, which are arranged on top of one another, and a vertical discharge duct 17b, is formed in the coupling frame 14. In the installed ventilation device, the respective gutter duct 17a is oriented horizontally with a deviation of up to 10° to the bottom, in order to be able to horizontally guide the water separated in the filter element 3 in the discharge duct assembly 17 under the influence of the force of gravity. The respective gutter duct 17a thereby in each case connects the drip-off regions 4b of the housings 4, which are adjacent in series, of the ventilation modules 2 in the stacking block 19. The two gutter ducts 17a are fluidically connected vertically via the discharge duct 17b. In the installed ventilation device 1, the vertical discharge duct 17b is oriented vertically with a deviation of up to 10° to the bottom, so that the water separated in the filter element 3 can be guided from the upper gutter duct 17a to the lower gutter duct 17a under the influence of the force of gravity. The water separated in the filter elements 3 is subsequently guided from the discharge duct assembly 17 into the collecting region 11b of the flow adapter 11, and further to the outside. For this purpose, the lower gutter duct 17a is fluidically connected at its lowest point through the discharge opening 28 to the collecting region 11b of the flow adapter. The several housings 4 and the several filter elements 3 are fluidically connected to one another in this way via the discharge duct assembly 17 in the coupling frame 14, and the water separated in the several filter elements 3 can be drained from the ventilation device 1 in a simplified manner.

In summary, the ventilation device 1 according to the invention can be constructed in a modular manner, and the ventilation modules 2, which are designed identically, can be interchanged in a simple way; the water separated in the respective filter element 3 can further be drained from the ventilation device 1 in a simplified manner; a sealing of the ventilation device 1 can be simplified, and the ventilation device 1 can be controlled more accurately, and the air flow can be better distributed in the respective filter element 3.

1. A ventilation device for filtering air and for separating water aerosols out of the air, comprising:
at least one filter element, at least one housing, at least one fan, and at least one flow adapter;
the at least one filter element secured in the at least one housing such that air is flowable through the at least one housing from an inlet opening of the at least one housing to an outlet opening of the at least one housing in a flow direction;
the at least one fan secured to the outlet opening downstream from the at least one housing in the flow direction;
the at least one flow adapter secured to the inlet opening upstream of the at least one housing in the flow direction;
a coupling frame secured in an airtight manner between the at least one housing and the at least one flow adapter transversely to the flow direction;
the at least one filter element having a circumferential sealing edge;
wherein the sealing edge rests against a sealing surface bordering the inlet opening of the at least one housing on one side, rests against the coupling frame on another side, and seals the at least one housing around the inlet opening to the coupling frame transversely to the flow direction.

2. The ventilation device according to claim 1, wherein an elastic seal is secured to a side surface of the sealing edge facing at least one of the at least one housing and the coupling frame.

3. The ventilation device according to claim 1, wherein the at least one flow adapter is structured as a single, integral piece and is composed of plastic.

4. The ventilation device according to claim 3, wherein:
the at least one flow adapter has a collecting region and a flow region;
the flow region of the at least one flow adapter corresponds in an air-conducting manner to the inlet opening of the at least one housing; and
the collecting region is arranged transversely to the flow direction in an offset manner below the flow region and outside of a main air flow of the at least one flow adapter.

5. The ventilation device according to claim 4, further comprising a discharge duct assembly fluidically connecting the collecting region of the at least one flow adapter and a drip-off region of the at least one housing to one another, wherein the drip-off region corresponds to a drainage zone of the at least one filter element for removing water separated in the at least one filter element.

6. The ventilation device according to claim 5, wherein the at least one flow adapter has an adapter outlet opening leading to an outside from the collecting region and connected in a fluid-conducting manner to the discharge duct assembly.

7. The ventilation device according to claim 5, wherein the discharge duct assembly is disposed within the coupling frame.

8. The ventilation device according to claim 7, wherein the discharge duct assembly includes at least one horizontal gutter duct fluidically connected to the drip-off region of the at least one housing.

9. The ventilation device according to claim 8, wherein the at least one gutter duct includes at least two gutter ducts arranged on top of one another and fluidically connected to one another via at least one vertical discharge duct.

10. The ventilation device according to claim 1, further comprising a plurality of identical ventilation modules, wherein:
the at least one filter element includes a plurality of filter elements, the at least one housing includes a plurality of housings, and the at least one fan includes a plurality of fans;
each individual ventilation module of the plurality of ventilation modules has a flow surface and is defined by a filter element of the plurality of filter elements, a housing of the plurality of housings, and a fan of the plurality of fans; and
the plurality of ventilation modules are detachably stacked against one another such that a total flow surface of the ventilation device corresponds to a multiple of the flow surface of the individual ventilation module.

11. The ventilation device according to claim 10, wherein:
at least two adjacent ventilation modules of the plurality of ventilation modules each have a cable part depression of a plurality of cable part depressions disposed in the respective housing and extending in the flow direction; and
the at least two adjacent ventilation modules rest against one another such that the plurality of cable part depressions are aligned in the flow direction and define a cable depression.

12. The ventilation device according to claim 11, wherein:
the housing of a first module of the at least two adjacent ventilation modules includes a recess extending in the flow direction;
the housing of a second module of the at least two adjacent ventilation modules includes at least one molding extending in the flow direction; and
the recess and the at least one molding engage one another transversely to the flow direction and detachably secure the at least two adjacent ventilation modules to one another.

13. The ventilation device according to claim 10, wherein:
the plurality of ventilation modules includes four ventilation modules;
the at least one flow adapter includes a single flow adapter; and
the four ventilation modules are detachably secured to one another to form a 2×2 stacking block and are secured in an air-conducting manner to the single flow adapter via the coupling frame.

14. The ventilation device according to claim 10, further comprising a hinge device and a closure unit, wherein:
the coupling frame includes a module support frame bordering the plurality of ventilation modules transversely to the flow direction and an adapter support frame supporting the at least one flow adapter; and
the module support frame and the adapter support frame are supported on one another in at least one of a hinged and a shiftable manner via the hinge device and are securable to one another via the closure unit.

15. The ventilation device according to claim 14, further comprising a discharge duct assembly for draining water collected in the at least one filter element, wherein the discharge duct assembly is disposed within the adapter support frame.

16. The ventilation device according to claim 10, further comprising an aperture assembly for the inlet opening of the housing of a respective ventilation module of the plurality of ventilation modules, wherein the aperture assembly is secured to the coupling frame transversely to the flow direction and is configured to control an air volume flow through the respective ventilation module.

17. The ventilation device according to claim 1, further comprising a control device including at least one measuring assembly structured and arranged to detect an air volume flow through the at least one filter element, wherein:
the at least one fan is controllable via the control device; and
the at least one measuring assembly includes a pressure measuring unit structured and arranged to detect a static pressure.

18. The ventilation device according to claim 17, wherein:
the pressure measuring unit at least one of (i) includes and (ii) is fluidically connected to a pressure measuring point; and
the pressure measuring point is arranged within the at least one housing in a region of the inlet opening and has a measuring opening.

19. The ventilation device according to claim 18, wherein at least one of the pressure measuring point and the measuring opening is arranged in a drip-off region of the at least one housing.

20. The ventilation device according to claim 18, wherein:
the at least one housing includes a housing frame, which borders the inlet opening and which has an inlet step protruding radially inwardly;
the pressure measuring point is arranged at the inlet step; and
the measuring opening is open in the flow direction and is oriented essentially parallel to the flow direction.
